(19) United States
(12) Patent Application Publication
(10) Pub. No.: US 2004/0133695 A1
(43) Pub. Date: Jul. 8, 2004

(54) Network-storage apparatus for high-speed streaming data transmission through network

(76) Inventors: Seong Woon Kim, Taejon (KR); Chong Won Park, Taejon (KR); Byung Kwon Jung, Taejon (TW)

Correspondence Address: JACOBSON, PRICE, HOLMAN & STERN, PROFESSIONAL LIMITED LIABILITY COMPANY, 400 Seventh Street, NW, Washington, DC, 20004, US

(21) Appl. No.: 10/676,116

(22) Filed: Oct. 2, 2003

(30) Foreign Application Priority Data
Dec. 23, 2002 (KR) 2002-82912

(51) Int. Cl. G06F 15/16; G06F 7/00; G06F 17/30

(52) U.S. Cl. 709/231; 707/10

(57) ABSTRACT

The present invention relates to a network-storage apparatus for storing the data received through network on a disk in the form of zero copy, and transmitting the streaming data stored on the disk to many users through network in the form of zero copy in high speed, thereby transmitting and receiving the streaming data in high speed through network for transmitting and receiving the streaming data rapidly through Internet. A network-storage apparatus of the present invention includes a peripheral device bus bridge for transferring bus transaction between a host processor and a network-storage apparatus; an internal peripheral device bus separated from a peripheral device bus outside the network-storage apparatus; a disk controller for managing reading and writing data from and to the disc storage; a peripheral memory for storing transmitted data between the disc storage and the network; a peripheral memory controller for storing or outputting the transmitted data between the disc storage and the network; and a TOE for reading data to be transmitted to the network from the peripheral memory, constructing the data in the form of a packet, transmitting the packet to the network, and storing the data received from the network and to be stored on the disk in the peripheral memory.

### BACKGROUND OF THE INVENITON

1. Field of the Invention

The present invention relates to a network-storage apparatus for streaming data transmission through network, and more particularly, to a network-storage apparatus for high-speed streaming data transmission through network, for transmitting data received through the network to a user directly without copying them through memory or storing them on a disk, and transmitting the streaming data on the disk through the network with high speed directly without copying them through memory thereby transmitting the streaming data through Internet with high speed.

2. Description of the Related Art

Recently, services for transmitting streaming data such as video-on-demand (VOD) and news-on-demand (NOD) have been used more and more often.

As transmission frequencies for Internet network go higher and higher, the computer server for transmitting the streaming data is required to have performance of higher efficiency. In other words, the amount of the data downloaded from the server through Internet increases as the number of users connected to the server increases.

The amount of data to be dealt with by a media server increases but the development speed of the operating system for the server does not catch up with the development speed of hardware.

To process the network services smoothly, TCP/IP that has been performed under the conventional operating system level is more and more frequently performed on external TCP/IP offload engine (TOE).

In other words, since the TOE, instead, performs the TCP/IP that has been performed under the conventional operating system level, the process of the server is used more than 90% so that the TCP/IP execution part which is the main factor that lowers the performance of the server is omitted and the overall system performance is improved. Owing to fast TOE execution, it is possible to response to the requests of the users through the network with high speed.

TOE is configured to process the TCP/IP function in the way of hardware. In fact, TOE has been implemented in ASIC and produced into a product.

It is disclosed in U.S. Pat. No. 6,427,173 B1 (Intelligent network interfaced device and system for accelerated communication).

The conventional art in which the TOE is used does not include disk access for transmitting the streaming data so that a host processor is overloaded in transmitting the streaming data.

Alternatively, iSCSI is used to share storage through network. The iSCSI enable to transmit SCSI block I/O protocol through the network by using general TCP/IP protocol.

There are many patents related to the iSCSI, especially, U.S. Pat. No. 6,400,730 (Method and apparatus for transferring data between IP network devices and SCSI and fibre channel devices over an IP network).

However, even though a system is implemented in iSCSI manner, when many users are connected to a server, a host is overloaded to provide the users with services.

On the other hand, when a great amount of streaming data is transmitted through Internet, the corresponding contents are copied quite a few times in a computer system. Such unplanned copy can not only lowers performance of Internet server but also make it difficult to provide streaming to ensure QoS.

Accordingly, required is an innovative organization of hardware of the computer that can satisfy the QoS of many users who use fast network. The organization of the hardware should improve performance of the network and access to streaming data fast.

### SUMMARY OF THE INVENTION

Accordingly, the present invention is directed to a network-storage apparatus for high-speed streaming data transmission through network that substantially obviates one or more problems due to limitations and disadvantages of the related art.

It is an object of the present invention to provide a network-storage apparatus for high-speed streaming data transmission through network, for storing the data received through network on a disk in the form of zero copy, and transmitting the streaming data stored on the disk to many users through network in the form of zero copy in high speed, thereby transmitting and receiving the streaming data in high speed through network for transmitting and receiving the streaming data rapidly through Internet.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a network-storage apparatus for high-speed streaming data transmission through a network and processing the streaming data for a plurality of disc storages of an Internet server computer system and a network apparatus includes an internal peripheral device bus separated from a peripheral device bus outside a network-storage apparatus, for transmitting data between devices inside the network-storage apparatus; a peripheral device bus bridge for transferring bus transaction from a host processor to the internal peripheral device bus and transferring bus transaction for a host processor executing inside the network-storage apparatus or a main memory to a bus bridge; a disk controller for controlling a plurality of disc storage connected to the network-storage apparatus and managing reading and writing data from and to the disc storage; a peripheral memory for storing transmitted data between the disc storage and the network; a peripheral memory controller for controlling the peripheral memory and storing or outputting the transmitted data between the disc storage and the network; and a TOE for reading data to be transmitted to the network from the peripheral memory, constructing the data in the form of a packet, transmitting the packet to the network, and storing the data received from the network in the peripheral memory through the peripheral memory controller.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates configuration of an Internet server computer system to which the present invention is applied;

FIG. 2 illustrates inner configuration of a network-storage apparatus according to the present invention;

FIG. 3 is a flow chart illustrating a receiving process of a network packet processing part according to the present invention;

FIG. 4 is a flow chart illustrating a transmitting process of a network packet processing part according to the present invention;

FIG. 5 is a flow chart illustrating a process of a storage disk controller according to the present invention; and

FIG. 6 is a flow chart illustrating an access to a peripheral memory device according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

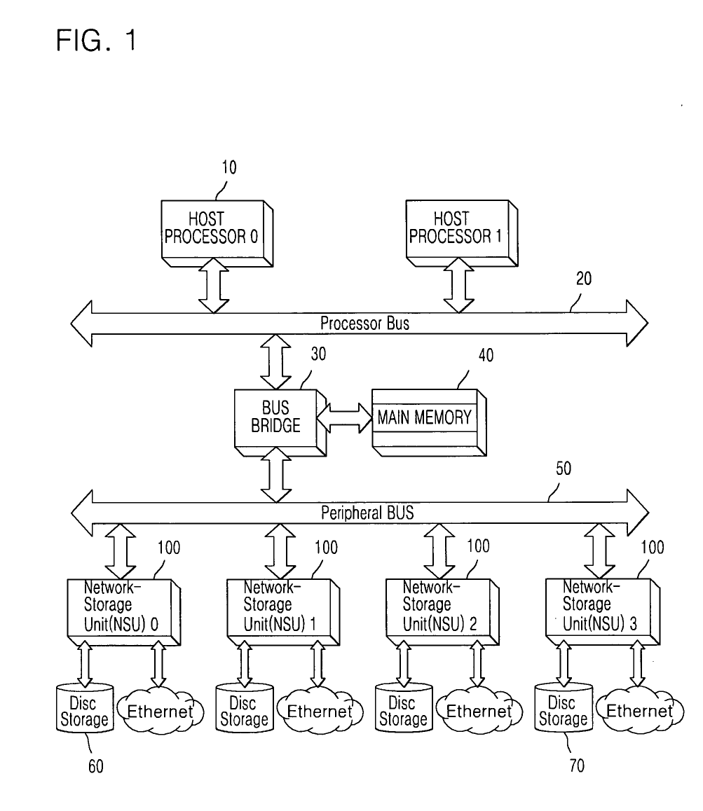

FIG. 1 illustrates configuration of an Internet server computer system to which the present invention is applied.

As shown in FIG. 1, generally, in an Internet server computer system, host processors 10 are connected to a processor bus 20 and the processor bus 20 is connected to a bus bridge 30 that accesses to a main memory 40 or connects to other peripheral device bus 30.

When bus transaction for instruction executed by the host processors 10 appears on the processor bus 20, the bus bridge 30 analyses the bus transaction and finds which device the bus transaction accesses to.

In general, this process is determined based on the address driven by an address bus and address region is allocated according to each device. If processor bus transaction accesses to the memory region, accesses to the main memory 40 and accesses to the peripheral device, the bus bridge 30 transfers the bus transaction to the peripheral device bus 50.

A PCI is usually used as the peripheral device bus 50.

The network-storage apparatus according to the present invention is connected to the peripheral device bus 50 and the number of the network-storage apparatuses that can be installed is the same as the number of devices that can be connected to the peripheral devices.

The network-storage apparatus (or network-storage unit, hereinafter, referred to as NSU) 100 according to the present invention behaves to be suit for an interface of the peripheral device bus 50 upwards and is connected to a disc storage 60 and a network 70 such as Ethernet.

Accordingly, when the NSU 100 receives the request of the host processor 10 transferred through the bus bridge 30 and accesses to a disk, the NSU 100 reads or writes data from or to the disc storage 60. When the NSU 100 receives the request of access to the network, the NSU 100 transfers a data packet through the network 70.

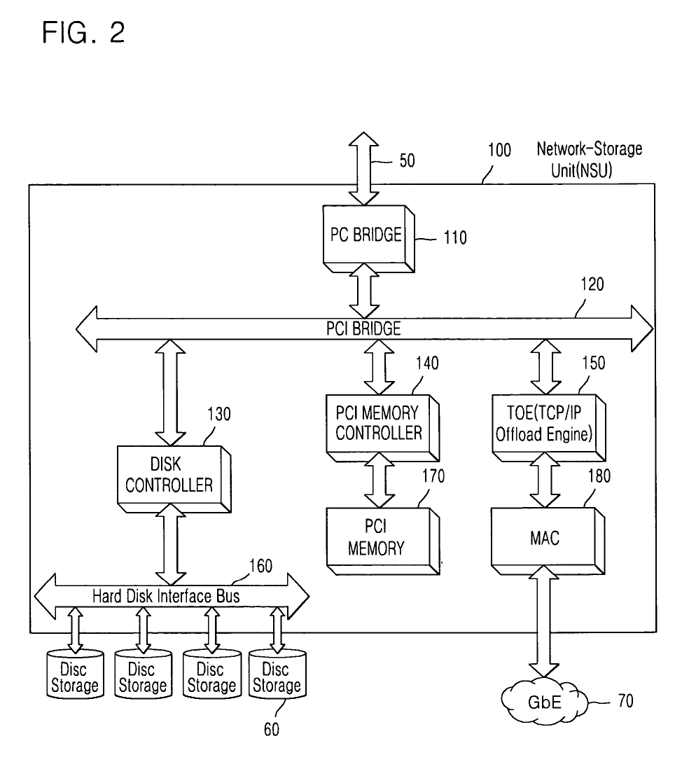

FIG. 2 illustrates inner configuration of a network-storage apparatus according to the present invention that behaves as described above.

As shown in FIG. 2, the NSU 100 according to the present invention includes a peripheral device bus bridge 110, a disk controller 130, a peripheral memory controller 140, a peripheral memory 170, a TCP/IP offload engine (TOE) 150 and a Medium access control (MAC) 180.

When the bus transaction required by the host processor 10 accesses to the NSU 100, the peripheral device bus bridge 110 transfers the transaction transmitted through the peripheral device bus 50 by the bus bridge 30 to a peripheral bus 120 inside the NSU 100 again.

Accordingly, the peripheral bus bridge 110 has a register for indicating address therein and stores information on various resources that are used by the NSU 100 while the system is initialized.

If PCI is used as the peripheral device bus, the peripheral device bus bridge 110 roles a PCI bridge.

The PCI bridge 110 is used to inform the host processor 10 of the bus transaction proceeding in the NSU, and transfers the transaction accessing to the main memory 40 to the bus bridge 30.

The PCI bridge 110 receives and transfers the bus transaction when the bus transaction proceeding by the processor accesses to PCI device.

One of the characteristics of the present invention is that the peripheral device bus 120 inside the NSU 100 is configured separated from the peripheral device bus 50 outside the NSU 100.

When the peripheral device bus is configured separately, the bus transaction between the network and the storage that proceeds inside the NSU 100 does not actually appear on the host peripheral device bus 50.

It can reduce the bus traffic of the host peripheral device bus 50 rapidly.

If there is not the peripheral device bus 120 inside the NSU, all the traffics are loaded on the host peripheral device bus 50 so that the host peripheral device bus 50 becomes a bottleneck even though the bus 50 is a PCI bus. When a plurality of the NSUs 100 are connected to the bus 50, the bottleneck phenomenon becomes more serious. Actually, if the PCI bus is a 32-bit bus, the bandwidth of the PCI bus is about 133 Mbytes/sec but it can process data of 1 Gbps of the network at most arithmetically.

However, as the present invention, if the NSU 100 has the bus 120 therein, the performance of the system does not deteriorate since the amount of the data transferred to the host peripheral device bus 50 can be reduce so much even though the bandwidth of the PCI bus does not match the bandwidth of the network.

The disk controller 130 can strip the disk 60 therein, distribute data to the various disks 60 and store the data on the various disks 60.

The disk stripping method is a method of dividing a great amount of data into groups of small amount of data and storing each of the groups on each of the disks when receiving the request of storing a great deal of data on disks 60 through the host processor 10 or the network 70. So, it can use all the disks simultaneously. It will work even when it is requested to access to another disk while a great amount of data is written on one disk at one time.

Usually, SCSI protocol is used for a disk interface bus 160. The capacity of data transmission of the SCSI protocol reaches about 160 Mbps or 320 Mbps recently. The method to use the data transmission bandwidth maximally is a disk stripping method.

Another important character of the present invention the NSU 100 has its own memory 170 therein so that the NSU 100 buffers data transmission between the storage and the network.

When data should be transmitted through the network, the peripheral memory controller 140 stores transmitted from the disk 60 in the peripheral memory 170. The contents in the peripheral memory 170 are transferred to the network 70 through TOE 150 again.

If the NSU 100 has a memory 170 therein, the problem that the data transmission rate of the storage does not match that of the network is removed and also the NSU 100 can cache a great amount of data. When it is requested to access to the disk 60 through the network 70, the NSU 100 does not access to the disk 60 again but provide the data in the memory 170 so as to maximize the network transmission efficiency since a large-sized PCI memory 170 is provided in the NSU 100.

The peripheral memory controller 140 controls the peripheral memory 170 and has a register for indicating the size of the peripheral memory 170. And also, the peripheral memory controller 140 can transmit a great deal of data in DMA manner.

The TOE 150 has the functions of the general TOE and the functions of the TOE 150 matches the configuration of the NSU 100.

The general TOE separates TCP/IP protocol by hardware and performs the TCP/IP protocol so that the packet transmission through the network gets fast.

The TOE suggested by the present invention has not only the functions of the general TOE but also other functions.

The function of the TOE will be described for two cases as follows.

First, when contents information in the disk 60 should be transferred in the form of packets through the network 70, the data to be transferred before transmission request is sent should be first stored in the peripheral memory 170.

The data read from the disk 60 and stored in the peripheral memory 170 is read from the peripheral memory 170 and transferred in the form of packets with various information required for network transmission if the instruction to perform transmission is received through the network.

At this time, the TOE 150 does not access to the main memory 40 but access to the peripheral memory 170 so that transaction is not transferred to the host peripheral device bus 50. So, the host processor 10 is not disturbed in its own behavior so that the overall system performance is improved.

Second, when the contents should be stored in the disk 60 through the network 70, the TOE 150 does not write the contents on the disk 60 directly but writes the data on the peripheral memory 170 through the peripheral memory controller 140 directly.

This method does not require using the host peripheral device bus 50. The TOE 150 cannot only interpret the packet information transmitted from the network but also knows whether the packet information should be stored on the disk. Consequently, the above-mentioned functions allow the contents information to be transferred to the disk 60. The path is provided so that the information of the disk 60 can be read and transmitted through the network 70 or the data transferred through the network 70 can be stored on the disk 60. So, the host processor 10 is not interrupted or loaded.

The offload function of the network-storage is the basic function of the NSU 100 according to the present invention.

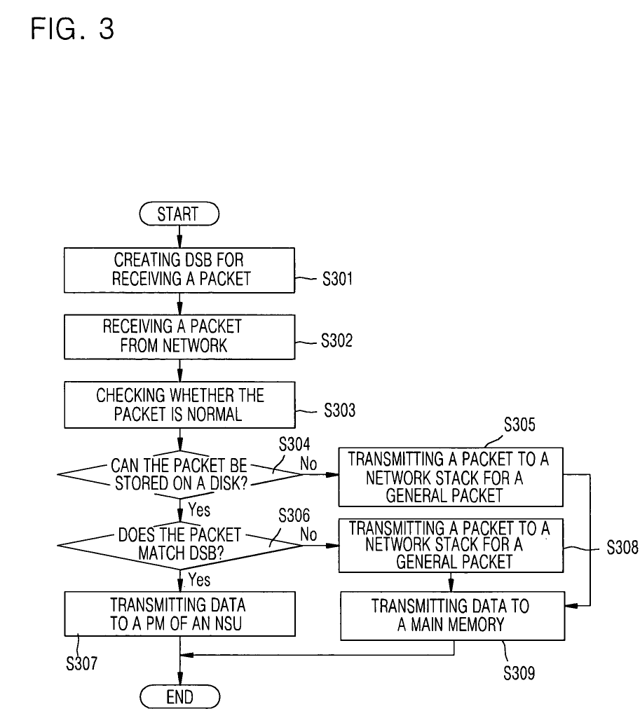

FIG. 3 is a flow chart illustrating a receiving process of a network packet processing part according to the present invention.

As shown in FIG. 3, since the host processor 10 knows that a received packet will appear, a disk save buffer table (DSB) is first generated and stored in the TOE 150 (S301).

The DSB is a table having information on the packet data to be immediately transferred to the disk 60 among the received packets.

After the DSB is first generated, the packet is received through the network 70 (S302).

When the packet is received, the TOE 150 checks whether the packet is normal (S303).

When checking the packet is finished, it is ascertain whether the packet can be stored on the disk 60 (S304). If the packet is a general packet that cannot be stored on the disk, the packet data are transferred to the network stack (S305).

If the packet can be stored on the disk, it is ascertain whether the already formed DSB has the information on the disk storage (S306).

Here, if there is information that matches the DSB, the information is transferred to the peripheral memory 170 of the NSU 100 (S307).

Unless there is information that matches the DSB, the information is transferred to the general network stack and processed in a general packet processing (S308 and S309).

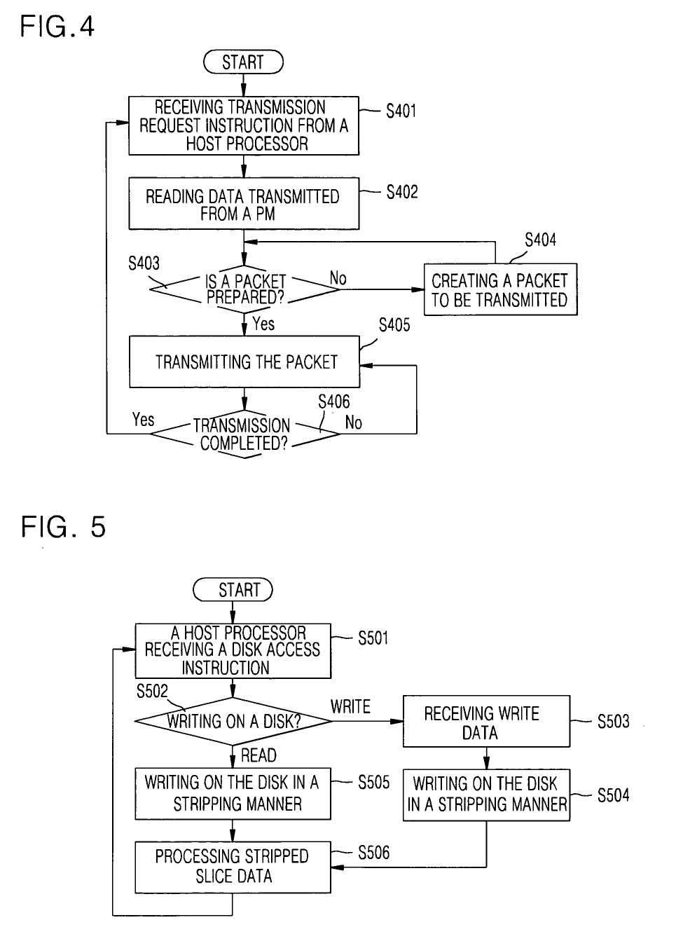

FIG. 4 is a flow chart illustrating a process of transmitting a packet through the TOE 150.

The streaming data read from the disk 60 are stored in the peripheral memory 170. When the data are transferred to the peripheral memory 170 completely, the instruction to request transferring the streaming data from the host processor 10 to the network 70 is received (S401).

When the data transmission instruction is received, the TOE 150 reads the corresponding data from the peripheral memory 170 (S402).

The read data is constructed in the form of a packet in the TOE 150 so that the data may be transmitted in the form of a packet.

It is ascertain whether the constructed packet is ready (S403). If the packet is not ready yet, the data in the peripheral memory 170 should be read and prepared (S404). If the packet is ready, the packet is transmitted through the network 70 (S405).

It is ascertain whether transferring the packet as much as the amount of the corresponding data is finished. If transferring the packet as much as the amount of the corresponding data is finished, the packet transfer is finished (S406).

FIG. 5 is a flow chart illustrating a process of reading and writing data on the disk by means of the disk controller 130.

When the instruction to access to the disk is received from the host processor 10 (S501), the disk controller 130 ascertains whether the instruction is to write data on the disk (S502).

If the instruction is to write data on the disk, the write data are received through the peripheral device bus 120 (S503). At this time, the write data are divided into stripping units and written on the disk 60 (S504).

If the instruction is to read data, the data on the disk 60 are read in a stripping unit of the disk 60 (S505).

The method to access to a plurality of disks in such small units in parallel makes the disk be accessed to in pipeline so that the disk access performance is improved.

Accordingly, when accessing to the disk in a stripping unit is finished (S506), the next disk access data will be processed.

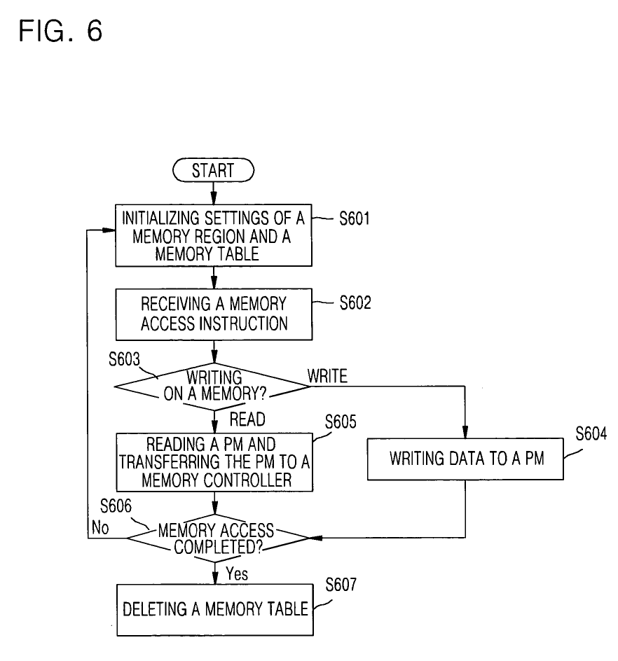

FIG. 6 is a flow chart illustrating a process of accessing to a peripheral memory device 170 through the memory controller 140.

To use the peripheral memory 170, an address range indication register should be initialized in the memory controller 140 (S601).

In other words, the memory controller 140 is initialized so as to indicate the region of the peripheral memory 170 in the NSU 100. Here, the memory table that has information on memory access should be confirmed.

The information on the memory access is a table used to find which part of the peripheral memory 170 is used by the processor.

When the memory controller 140 receives the instruction to access to the peripheral memory, the fact that the peripheral memory is used with the corresponding address is marked on the memory table (S602).

When it is requested to access to the disk, this information is used to check whether the data is already read from the disk 60 and stored in the memory 170. In other words, the peripheral memory is used as a network cache

It is ascertained whether the access instruction is memory write (S603). If the access instruction is memory write, the received write data is written in the peripheral memory 170 (S604). If the access instruction is memory read, the data is read from the peripheral memory 170 and transferred to the memory controller 140 (S605).

It is ascertained whether the memory is accessed to completely (S606). If the memory is accessed to completely, the value of the memory table is removed (S607).

If the value of the memory table remains to be valid, it is recognized that the corresponding value of the memory is still valid. So, when using memory is finished, the memory is cleared.

As described above, the network-storage apparatus for transmitting and receiving streaming data through the network according to the present invention at high speed processes the streaming data of the network and the disk in the form of zero copy so that the load on the host processor of the server is reduced and the streaming data are transmitted and received through Internet at high speed.

The frequency of the memory copy of the streaming data of the disk is reduced and the interference of the processor is minimized so that the high quality of the streaming data can be supported in QoS.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A network-storage apparatus for high-speed streaming data transmission through a network, the network-storage apparatus processing the streaming data for a plurality of disc storages of an Internet server computer system and a network apparatus, the apparatus comprising:
an internal peripheral device bus separated from a peripheral device bus outside the network-storage apparatus, for transmitting data between devices inside the network-storage apparatus;
a peripheral device bus bridge for transferring bus transaction from a host processor to the internal peripheral device bus and transferring bus transaction for a host processor executing inside the network-storage apparatus or a main memory to a bus bridge;
a disk controller for controlling a plurality of disc storage connected to the network-storage apparatus and managing reading and writing data from and to the disc storage;
a peripheral memory for storing transmitted data between the disc storage and the network;
a peripheral memory controller for controlling the peripheral memory and storing or outputting the transmitted data between the disc storage and the network; and
a TOE for reading data to be transmitted to the network from the peripheral memory, constructing the data in the form of a packet, transmitting the packet to the network, and storing the data received from the network in the peripheral memory through the peripheral memory controller.

2. The apparatus of claim 1, wherein the peripheral device bus is a PCI bus and the peripheral device bus bridge roles a PCI bridge.

3. The apparatus of claim 1, wherein the disk controller is connected to a plurality of disc storages in parallel through a disk interface bus and accesses to the data in a pipeline manner.

4. The apparatus of claim 1, wherein the disk controller reads and writes data from and to a plurality of disc storages in a stripping manner.

5. The apparatus of claim 1, wherein the peripheral memory controller constructs a memory table so as to cache data transmitted from and to the network.

6. The apparatus of claim 1, wherein the peripheral memory controller is provided a register for indicating size of the peripheral memory inside the peripheral memory controller, and transmits a great deal of data in a DMA manner.

7. The apparatus of claim 1, wherein the peripheral memory controller deletes contents of a memory table thereof when finishing accessing to the peripheral memory.

8. The apparatus of claim 1, wherein the TOE creates a DSB table having information on packet data to be transferred to the disk immediately among data packets received from the network, transmitting a data packet to the peripheral memory to store the data packet if the data packet storable in the disk has information matching DSB, and transmitting a data packet to a general network stack otherwise.

9. The apparatus of claim 1, wherein the TOE reads data to be transmitted to the network from the peripheral memory, constructs the data in the form of a packet and transfers the data packet to the network when the data to be transmitted is stored in the peripheral memory and the TOE receives a data transmission instruction from a host processor.
